(19) United States
(12) Patent Application Publication
(10) Pub. No.: US 2024/0340403 A1
(43) Pub. Date: Oct. 10, 2024

(54) HEAD MOUNT DISPLAY, INFORMATION PROCESSING APPARATUS, AND INFORMATION PROCESSING METHOD

(71) Applicant: SONY GROUP CORPORATION, TOKYO (JP)

(72) Inventors: HIROTAKE ICHIKAWA, TOKYO (JP); DAITA KOBAYASHI, TOKYO (JP); TAKUMI HAMASAKI, TOKYO (JP); ATSUSHI ISHIHARA, TOKYO (JP); YUKI MORIKUBO, TOKYO (JP)

(21) Appl. No.: 18/700,002

(22) PCT Filed: Oct. 7, 2022
(86) PCT No.: PCT/JP2022/037676

§ 371 Date: Apr. 10, 2024

(30) Foreign Application Priority Data
Oct. 18, 2021 (JP) 2021-170118

(51) Int. Cl. H04N 13/344; H04N 13/239; H04N 13/383

(52) U.S. Cl. CPC H04N 13/344; H04N 13/239; H04N 13/383

(57) ABSTRACT

A head mount display includes: a left display that displays a left-eye display image; a right display that displays a right-eye display image; a housing that supports the left display and the right display so as to be located in front of eyes of a user; and a left camera that captures a left camera image, and a right camera that captures a right camera image, the left camera and the right camera being provided outside the housing, in which an interval between the left camera and the right camera is wider than an interocular distance of the user.

### TECHNICAL FIELD

The present technology relates to a head mount display, an information processing apparatus, and an information processing method.

### BACKGROUND ART

There is a function called video see through (VST) in a virtual reality (VR) device such as a head mount display (HMD) including a camera. Usually, when the HMD is worn, the field of view is blocked by the display and the housing, and a user cannot see the outside state. However, by displaying an image of the outside world captured by the camera on a display included in the HMD, the user can see the outside state while the HMD is worn.

In the VST function, it is physically impossible to completely match the positions of the camera and the user's eyes, and parallax always occurs between the two viewpoints. Therefore, when an image captured by the camera is displayed on the display as it is, a size of an object and binocular parallax are slightly different from the reality, so that spatial discomfort occurs. It is considered that this discomfort hinders interaction with a real object or causes VR sickness.

Therefore, it is considered to solve this problem using a technology called “viewpoint conversion” that reproduces an outside world video viewed from a position of the user's eye on the basis of the outside world video (color information) captured by a VST camera and geometry (three-dimensional topography) information.

The VST camera for viewing the outside world in an HMD having the VST function is usually disposed at a position in front of the HMD and in front of the user's eye due to structural restrictions. Furthermore, in order to minimize the parallax between a camera video and an actual eye position, an image of a left-eye display is usually generated by an image from a left camera, and an image of a right-eye display is usually generated by a video from a right camera.

However, when the image of the VST camera is displayed as it is on the display of the HMD, the image becomes a video in which the eyes jump out. To avoid this, a viewpoint conversion technology is used. The respective images of the left and right cameras are deformed on the basis of the geometry information of the surrounding environment obtained by a distance measurement sensor, and the original image is deformed so as to be approximated to the image viewed from the position of the user's eye.

In this case, it is preferable that the original image is captured at a distance close to the user's eye since a difference from the final viewpoint video is small. Therefore, it is usually considered ideal to place the VST camera in a position that minimizes a distance between the VST camera and the user's eye, that is, to place the VST camera in a straight line of the user's eye.

However, when the VST camera is disposed in such a manner, there is a problem that an occlusion region due to an occluding object greatly appears. Therefore, in an imaging system including a plurality of physical cameras, there is a technology of generating a video from a virtual camera viewpoint on the basis of camera videos from a plurality of viewpoints (Patent Document 1).

### CITATION LIST

### Patent Document

Patent Document 1: Japanese Patent Application Laid-Open No. 2012-201478

### SUMMARY OF THE INVENTION

### Problems to be Solved by the Invention

In Patent Document 1, after generating a virtual viewpoint video from a color image and a distance image in a main camera closest to a final virtual camera viewpoint, a virtual viewpoint video for an occlusion region of the main camera is generated on the basis of a color image and a distance image of a sub camera group second closest to the final virtual camera viewpoint. However, it is not sufficient to reduce the occlusion region that is a problem in the HMD.

The present technology has been made in view of such a problem, and an object thereof is to provide a head mount display, an information processing apparatus, and an information processing method capable of reducing an occlusion region generated in an image displayed on the head mount display having a VST function.

### Solutions to Problems

In order to solve the above-described problem, a first technology is a head mount display including: a left display that displays a left-eye display image; a right display that displays a right-eye display image; a housing that supports the left display and the right display so as to be located in front of eyes of a user; and a left camera that captures a left camera image, and a right camera that captures a right camera image, the left camera and the right camera being provided outside the housing, in which an interval between the left camera and the right camera is wider than an interocular distance of the user.

Furthermore, a second technology is an information processing apparatus configured to: perform processing corresponding to a head mount display including a left camera and a left display, and a right camera and a right display; generate a left-eye display image by projecting a left camera image captured by the left camera onto a viewpoint of the left display and sampling a pixel value; and generate a right-eye display image by projecting a right camera image captured by the right camera onto a viewpoint of the right display and sampling a pixel value.

Moreover, a third technology is an information processing method including: performing processing corresponding to a head mount display including a left camera and a left display, and a right camera and a right display; generating a left-eye display image by projecting a left camera image captured by the left camera onto a viewpoint of the left display and sampling a pixel value; and generating a right-eye display image by projecting a right camera image captured by the right camera onto a viewpoint of the right display and sampling a pixel value.

### BRIEF DESCRIPTION OF DRAWINGS

FIG. 1A is an external perspective view of an HMD 100, and FIG. 1B is an inner view of a housing 150 of the HMD 100.

FIG. 2 is a block diagram illustrating a configuration of the HMD 100.

FIG. 3 is a diagram illustrating an arrangement of a left camera, a right camera, a left display, and a right display in a conventional HMD 100.

FIG. 4 is a diagram illustrating an arrangement of a left camera, a right camera, a left display, and a right display in the HMD 100 of the present technology.

FIG. 5 is an explanatory diagram of an occlusion region generated by an arrangement of conventional color camera and display.

FIG. 6 is an explanatory diagram of an occlusion region generated by an arrangement of a color camera and a display of the present technology.

FIG. 7 is a simulation result of an occlusion region generated by an arrangement of the conventional color camera and display.

FIG. 8 is a simulation result of an occlusion region generated by an arrangement of the color camera and the display of the present technology.

FIG. 9 is a process block diagram for generating a left-eye display image of an information processing apparatus 200 according to a first embodiment.

FIG. 10 is an explanatory diagram of processing of the information processing apparatus 200 according to the first embodiment.

FIG. 11 is an explanatory diagram of processing of the information processing apparatus 200 according to the first embodiment.

FIG. 12 is an image illustrating a result of processing of the information processing apparatus 200 in the first embodiment.

FIG. 13 is a process block diagram for generating a right-eye display image of the information processing apparatus 200 according to the first embodiment.

FIG. 14 is an explanatory diagram of distance measurement error detection.

FIG. 15 is a process block diagram for generating a left-eye display image of an information processing apparatus 200 in a second embodiment.

FIG. 16 is a process block diagram for generating a right-eye display image of the information processing apparatus 200 according to the second embodiment.

FIG. 17 is a diagram illustrating a modification of the HMD 100.

### MODE FOR CARRYING OUT THE INVENTION

Hereinafter, embodiments of the present technology will be described with reference to the drawings. Note that the description will be made in the following order.
<1. First embodiment>
[1-1. Configuration of HMD 100]
[1-2. Processing by information processing apparatus 200]
<2. Second embodiment>
[2-1. Description of distance measurement error]
[2-2. Processing by information processing apparatus 200]
<3. Modifications>

### 1. First Embodiment

### [1-1. Configuration of HMD 100]

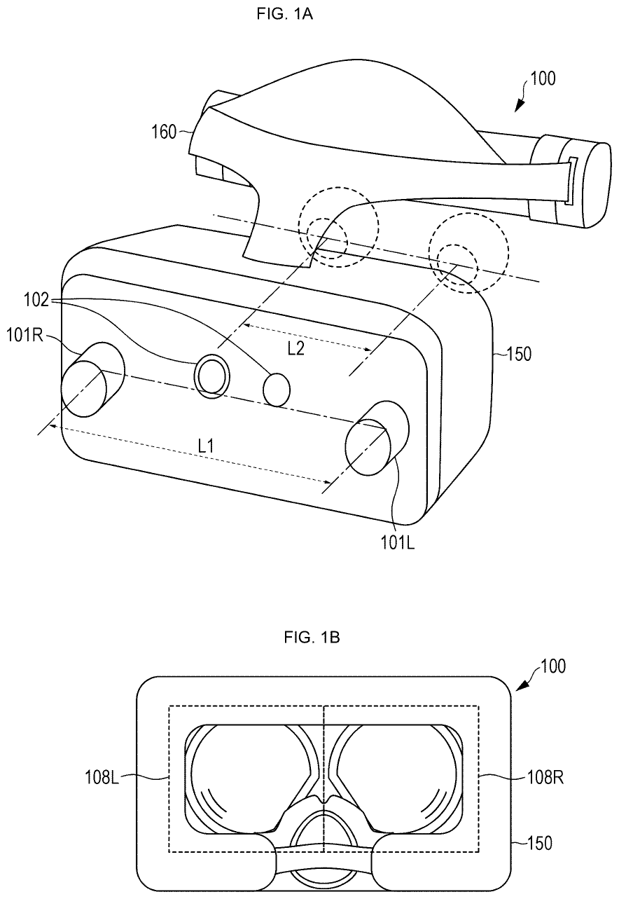

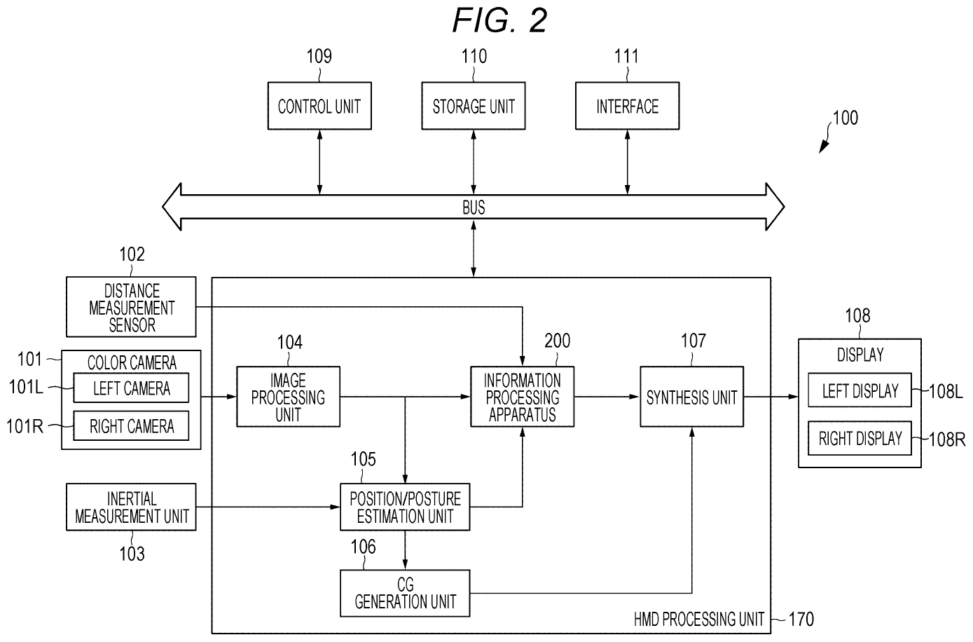

A configuration of an HMD 100 having the VST function will be described with reference to FIGS. 1 and 2. The HMD 100 includes a color camera 101, a distance measurement sensor 102, an inertial measurement unit 103, an image processing unit 104, a position/posture estimation unit 105, a CG generation unit 106, an information processing apparatus 200, a synthesis unit 107, a display 108, a control unit 109, a storage unit 110, and an interface 111.

The HMD 100 is worn by a user. As illustrated in FIG. 1, the HMD 100 includes a housing 150 and a band 160. A housing 150 houses the display 108, a circuit board, a processor, a battery, an input/output port, and the like. Furthermore, the color camera 101 and the distance measurement sensor 102 are provided in front of the housing 150.

The color camera 101 includes an imaging element, a signal processing circuit, and the like, and is a camera capable of capturing a color image and a color video of red, green, blue (RGB) or a single color. The color camera 101 includes a left camera 101L that captures an image to be displayed on a left display 108L, and a right camera 101R that captures an image to be displayed on a right display 108R. The left camera 101L and the right camera 101R are provided outside the housing 150 toward a direction of a user's line-of-sight, and capture the outside world in the direction of the user's line-of-sight. In the following description, an image obtained by capturing by the left camera 101L is referred to as a left camera image, and an image obtained by capturing by the right camera 101R is referred to as a right camera image.

The distance measurement sensor 102 is a sensor that measures a distance to a subject and acquires depth information. The distance measurement sensor is provided outside the housing 150 in the direction of the user's line-of-sight. The distance measurement sensor 102 may be an infrared sensor, an ultrasonic sensor, a color stereo camera, an infrared (IR) stereo camera, or the like. Furthermore, the distance measurement sensor 102 may be triangulation or the like using one IR camera and a structured light. Note that the depth is not necessarily the depth of stereo as long as the depth information can be acquired, and may be a monocular depth using time of flight (ToF) or motion parallax, a monocular depth using an image plane phase difference, or the like.

The inertial measurement unit 103 is various sensors that detect sensor information for estimating a posture, inclination, and the like of the HMD 100. The inertial measurement unit 103 is, for example, an inertial measurement unit (IMU), an acceleration sensor, an angular velocity sensor, a gyro sensor, or the like with respect to two or three axis directions.

The image processing unit 104 performs predetermined image processing such as analog/digital (A/D) conversion white balance adjustment processing, color correction processing, gamma correction processing, Y/C conversion processing, and auto exposure (AE) processing on the image data supplied from the color camera 101. Note that the image processing described here is merely an example, and it is not necessary to perform all of them, and other processing may be further performed.

The position/posture estimation unit 105 estimates a position, posture, and the like of the HMD 100 on the basis of the sensor information supplied from the inertial measurement unit 103. By estimating the position and posture of the HMD 100 by the position/posture estimation unit 105, the position and posture of the head of the user wearing the HMD 100 can also be estimated. Note that the position/posture estimation unit 105 can also estimate the movement, inclination, and the like of the HMD 100. In the following description, the position of the head of the user wearing the HMD 100 is referred to as a self-position, and estimating the position of the head of the user wearing the HMD 100 by the position/posture estimation unit 105 is referred to as self-position estimation.

The information processing apparatus 200 performs processing according to the present technology. The information processing apparatus 200 uses a color image captured by the color camera 101 and a depth image generated from depth information obtained by the distance measurement sensor 102 as inputs, and generates a left-eye display image and a right-eye display image in which an occlusion region caused by an occluding object is compensated. The left-eye display image and the right-eye display image are supplied from the information processing apparatus 200 to the synthesis unit 107. Then, finally, the left-eye display image is displayed on the left display 108L, and the right-eye display image is displayed on the right display 108R. Details of the information processing apparatus 200 will be described later.

Note that the information processing apparatus 200 may be configured as a single apparatus, may operate in the HMD 100, or may operate in an electronic device such as a personal computer, a tablet terminal, or a smartphone connected to the HMD 100. Furthermore, the HMD 100 or the electronic device may execute the function of the information processing apparatus 200 by a program. In a case where the information processing apparatus 200 is realized by the program, the program may be installed in the HMD 100 or the electronic device in advance, or may be distributed by download, a storage medium, or the like and installed by the user himself/herself.

The CG generation unit 106 generates various computer graphic (CG) images to be superimposed on the left-eye display image and the right-eye display image for augmented reality (AR) display and the like.

The synthesis unit 107 synthesizes the CG image generated by the CG generation unit 106 with the left-eye display image and the right-eye display image output from the information processing apparatus 200 to generate an image to be displayed on the display 108.

The display 108 is a liquid crystal display, an organic electroluminescence (EL) display, or the like located in front of the eyes of the user when the HMD 100 is worn. As illustrated in FIG. 1B, the display 108 includes the left display 108L and the right display 108R. As indicated by broken lines in FIG. 1B, the left display 108L and the right display 108R are supported so as to be located in front of the eyes of the user inside the housing 150. The left display 108L displays a left-eye display image created from an image captured by the left camera 101L. The right display 108R displays a right-eye display image created from an image captured by the right camera 101R. VST is realized by displaying the left-eye display image on the left display 108L and the right-eye display image on the right display 107R, and the user can see the state of the outside world while wearing the HMD 100.

The image processing unit 104, the position/posture estimation unit 105, the CG generation unit 106, the information processing apparatus 200, and the synthesis unit 107 constitute an HMD processing unit 170, and after image processing and self-position estimation are performed by the HMD processing unit 170, only an image subjected to viewpoint conversion or an image generated by synthesizing the image subjected to viewpoint conversion and the CG is displayed on the display 108.

The control unit 109 includes a central processing unit (CPU), a random access memory (RAM), a read only memory (ROM), and the like. The CPU controls the entire HMD 100 and each unit by executing various processing according to a program stored in the ROM and issuing commands. Note that the information processing apparatus 200 may be implemented by processing by the control unit 109.

The storage unit 110 is, for example, a mass storage medium such as a hard disk or a flash memory. The storage unit 110 stores various applications operating on the HMD 100, various information used in the HMD 100 and the information processing apparatus 200, and the like.

The interface 111 is an interface with an electronic device such as a personal computer or a game machine, the Internet, or the like. The interface 111 may include a wired or wireless communication interface. Furthermore, more specifically, the wired or wireless communication interface might include cellular communication such as 3TTE, Wi-Fi, Bluetooth (registered trademark), near field communication (NFC), Ethernet (registered trademark), high-definition multimedia interface (HDMI (registered trademark)), universal serial bus (USB) and the like.

Note that the HMD processing unit 170 illustrated in FIG. 2 may operate in the HMD 100 or may operate in an electronic device such as a personal computer, a game machine, a tablet terminal, or a smartphone connected to the HMD 100. In a case where the HMD processing unit 170 operates in an electronic device, a camera image captured by the color camera 101, depth information acquired by the distance measurement sensor 102, and sensor information acquired by the inertial measurement unit 103 are transmitted to the electronic device via the interface 111 and a network (wire or wireless). Furthermore, the output from the synthesis unit 107 is transmitted to the HMD 100 via the interface 111 and the network and displayed on the display 108. Note that the HMD 100 may be configured as a wearable device such as a glasses-type without the band 160, or may be configured integrally with a headphone or an earphone. Furthermore, the HMD 100 may be configured to support not only an integrated HMD but also an electronic device such as a smartphone or a tablet terminal by fitting the electronic device into a band-shaped attachment or the like.

Next, the arrangement of the left camera 101L, the right camera 101R, the left display 108L, and the right display 108R in the HMD 100 will be described. As illustrated in FIG. 1A, in the present technology, an interval L1 between the left camera 101L and the right camera 101R is disposed to be wider than an interval (interocular distance) L2 between the left display 108L and the right display 108R.

The position of the left display 108L may be considered to be the same as the position of the left eye of the user, which is a virtual viewpoint to be finally synthesized. Thus, the left display viewpoint is the user's left eye viewpoint. Furthermore, the position of the right display 108R may be considered to be the same as the position of the right eye of the user, which is a virtual viewpoint to be finally synthesized. Thus, the right display viewpoint is the user's right eye viewpoint. Therefore, the interval between the left display 108L and the right display 108R is the interocular distance between the left eye and the right eye of the user. The interocular distance is a distance (interpupillary distance) from a center of the black eye (pupil) of the left eye of the user to a center of the black eye (pupil) of the right eye. Furthermore, the interval between the left display 108L and the right display 108R is, for example, a distance between a specific position (center or the like) in the left display 108L and a specific position (center or the like) in the right display 108R.

In the following description, the viewpoint of the left camera 101L is referred to as a left camera viewpoint, and the viewpoint of the right camera 101R is referred to as a right camera viewpoint. Furthermore, the viewpoint of the left display 108L is referred to as a left display viewpoint, and the viewpoint of the right display 108R is referred to as a right display viewpoint. Moreover, the viewpoint of the distance measurement sensor 102 is referred to as a distance measurement sensor viewpoint. The display viewpoint is a virtual viewpoint calibrated to simulate the visual field of the user at the position of the user's eye.

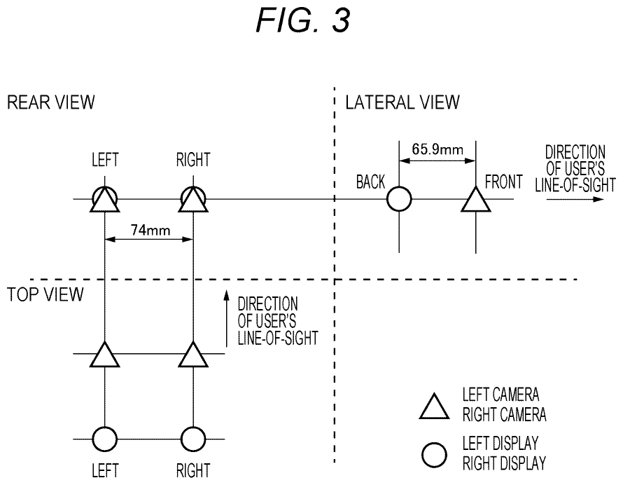

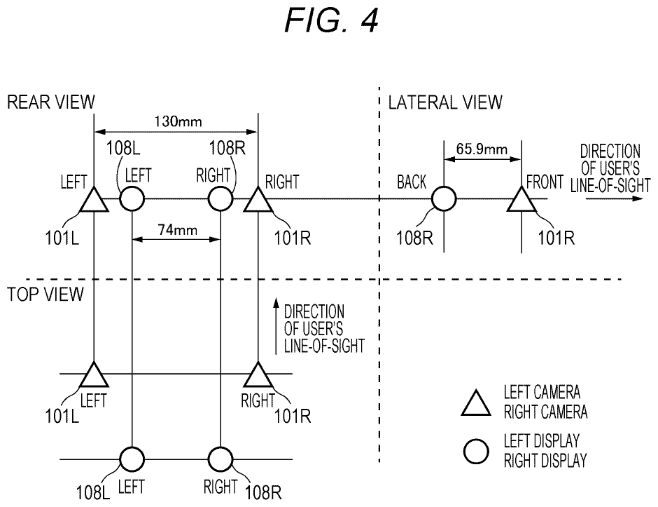

The arrangement of the left camera 101L, the right camera 101R, the left display 108L, and the right display 108R will be described in detail with reference to FIGS. 3 and 4. Note that, in FIGS. 3 and 4, the left camera 101L and the right camera 101R are indicated by triangular icons, and the left display 108L and the right display 108R are indicated by circular icons. The actual left camera 101L, the right camera 101R, the left display 108L, and the right display 108R have widths and thicknesses, but in FIGS. 3 and 4, icons indicate substantially central positions of the respective cameras and displays.

Conventionally, as illustrated in a rear view and a top view in FIG. 3, the left camera, the right camera, the left display, and the right display are disposed so that an interval between the left camera and the right camera is equal to an interval (interocular distance) between the left display and the right display. In other words, the left camera, the right camera, the left display, and the right display are disposed so that a difference between the interval between the left camera and the right camera and the interval (interocular distance) between the left display and the right camera becomes minimum. Note that, as illustrated in the rear view and the lateral view, the left camera, the right camera, the left display, and the right display are disposed at substantially the same height.

On the other hand, in the present technology, as illustrated in the rear view and the top view of FIG. 4, the left camera, the right camera, the left display, and the right display are disposed so that an interval between the left camera 101L and the right camera 101R is wider than an interval (interocular distance) between the left display 108L and the right display 108R. The interval between the left camera 101L and the right camera 101R in rear view and top view is, for example, 130 mm. Furthermore, the interval (interocular distance) between the left display 108L and the right display 108R is, for example, 74 mm.

A person's interocular distance is statistically 72 mm or more, and can cover 99% of men. Furthermore, 95% of men can be covered with 70 mm or more, and 99% of men can be covered with 72.5 mm or more. Therefore, the interocular distance is only required to be set to about 74 mm at the maximum, and the left camera 101L and the right camera 101R is only required to be disposed so that the interval is 74 mm or more. Note that the interval between the left camera 101L and the right camera 101R and the interocular distance are merely examples, and the present technology is not limited to these values.

As illustrated in a horizontal view, the right camera 101R is provided in front of the right display 108R in the direction of the user's line-of-sight. A relationship between the left camera 101L and the left display 108L is also similar.

Note that, in some HMDs 100, the positions of the left display 108L and the right display 108R can be laterally adjusted in accordance with the size of the user's face and the interocular distance. In the case of such an HMD 100, the left camera 101L and the right camera 101R are disposed such that the interval between the left camera 101L and the right camera 101R is wider than the maximum interval between the left display 108L and the right display 108R.

As illustrated in the rear view and the lateral view, the left camera 101L, the right camera 101R, the left display 108L, and the right display 108R are disposed at substantially the same height similarly to the related art. As illustrated in the lateral view, an interval between the right camera 101R and the right display 108R is, for example, 65.9 mm. An interval between the left camera 101L and the left display 108L is also the similar.

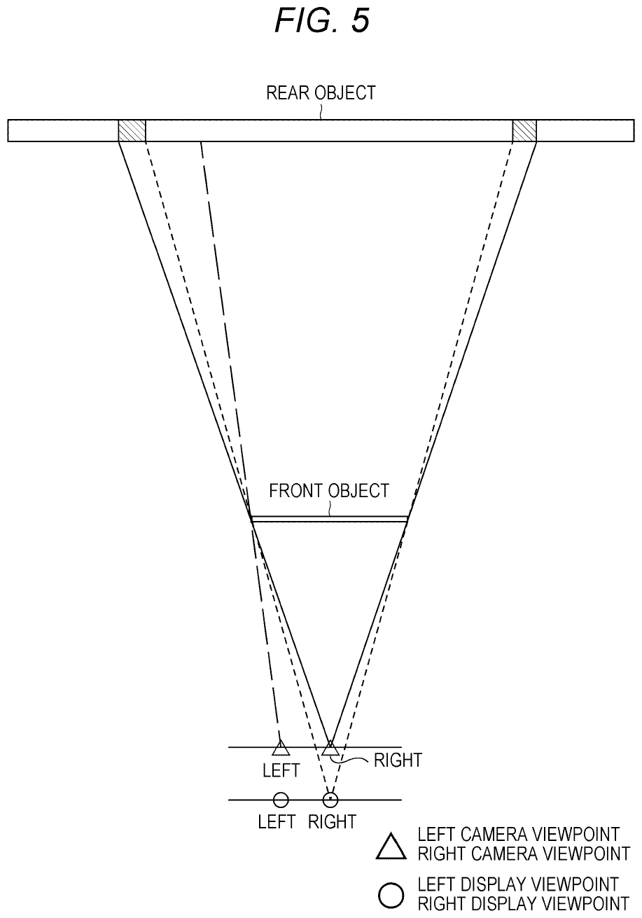

In the conventional arrangement of the color camera and the display illustrated in FIG. 3, as illustrated in FIG. 5, there is a problem that an occlusion region due to an occluding object occurs on both the left and right and becomes large. In FIG. 5, it is assumed that a rear object on the far side and a front object on the near side exist in front of the user wearing the HMD 100. Furthermore, it is assumed that the front object is smaller in width than the rear object. The front object serves as an occluding object for the rear object.

The inside of the solid line extending in a fan shape from the right camera viewpoint is a region where the rear object cannot be seen due to the front object (occluding object) at the right camera viewpoint. Furthermore, the inside of the broken line extending in a fan shape from the right display viewpoint is a region where the rear object cannot be seen due to the front object (occluding object) at the right display viewpoint.

Considering a positional relationship between the right camera viewpoint and the right display viewpoint, the shaded region of the rear object existing on the far side is not visible from the right camera viewpoint, but is visible from the right display viewpoint, that is, the right eye of the user. This region is an occlusion region by a front object (an occluding object) when an image captured by the right camera is displayed on the right display.

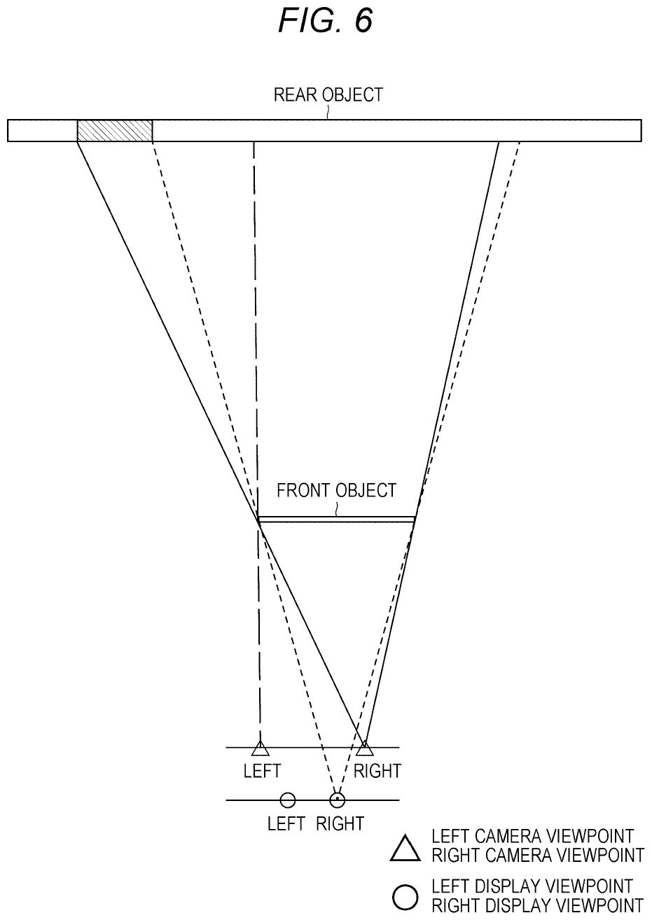

Meanwhile, FIG. 6 is a diagram illustrating generation of an occlusion region by the arrangement of the left camera 101L, the right camera 101R, the left display 108L, and the right display 108R in the present technology illustrated in FIG. 4. The size and arrangement of the rear object and the front object are similar to those in FIG. 4. The inside of the solid line extending in a fan shape from the right camera viewpoint is a region where the rear object cannot be seen due to the front object (occluding object) at the right camera viewpoint. Furthermore, the inside of the broken line extending in a fan shape from the right display viewpoint is a region where the rear object cannot be seen due to the front object (occluding object) at the right display viewpoint.

Considering a positional relationship between the right camera viewpoint and the right display viewpoint, the occlusion region that has occurred on the right side as viewed from the user in the conventional arrangement does not occur. Note that an occlusion region indicated by hatching is generated on the left side as viewed from the user, but this can be compensated by the left camera image captured by the left camera 101L on the opposite side.

In this manner, by configuring the interval between the left camera 101L and the right camera 101R to be wider than the interval (interocular distance) between the left display 108L and the right display 108R, it is possible to reduce the occlusion region generated by the occluding object.

The distance measurement sensor 102 is, for example, between the left camera 101L and the right camera 101R, and is provided at the same height as the left camera 101L and the right camera 101R. However, there is no particular limitation on the position of the distance measurement sensor 102, and the distance measurement sensor 102 may be provided so as to be capable of sensing toward the direction of the user's line-of-sight.

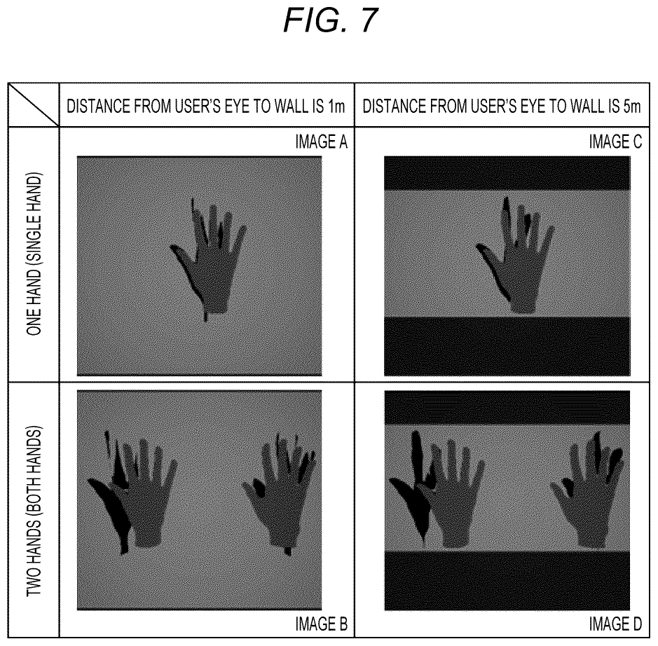

FIG. 7 is a simulation result of an occlusion region generated in a display image by a front object in the arrangement of the conventional color camera and the display illustrated in FIG. 3. In this simulation, the hand of the user wearing the HMD 100 is a front object (an occluding object), and the wall is a rear object. The hand shall be located 25 cm from the user's eye.

Among the four images illustrated in FIG. 7, two images on the left side (image A and image B) illustrate a case where the distance from the user's eye to the wall (rear object) is 1 m. Furthermore, the two images on the right side (image C and image D) of the four images illustrate a case where the distance from the user's eye to the wall (rear object) is 5 m.

Furthermore, among the four images illustrated in FIG. 7, the upper two (image A and image C) illustrate a case where only one hand (front object) of the user exists within the angle of view. Furthermore, the lower two images (image B and image D) illustrate a case where both hands (front object) of the user exist within the angle of view. Note that, in the image B and the image D, the right hand is the user's right hand with the palm facing the direction opposite to the direction of the user's face (the direction of the user's line-of-sight), and the left hand is the user's left hand with the palm facing the direction of the user's face.

Each of images A to D in FIG. 7 is a result of drawing a left-eye viewpoint image (an image displayed on the left display 108L) of the user. A black region in the image is an occlusion region generated by a hand (front object) not illustrated in either the left camera 101L or the right camera 101R. It can be seen that, in a case where the distance from the user's eye to the wall is 5 m more than in a case where the distance is 1 m, that is, as the distance to the wall (rear object) shielded by the hand (front object) is longer, the occlusion region becomes larger. Furthermore, it can be seen that the occlusion region becomes larger as the hand (front object) exists closer to the end of the field of view. As a result, it can be seen that the occlusion region cannot be completely compensated even by using the left camera image captured by the left camera 101L and the right camera image captured by the right camera 101R.

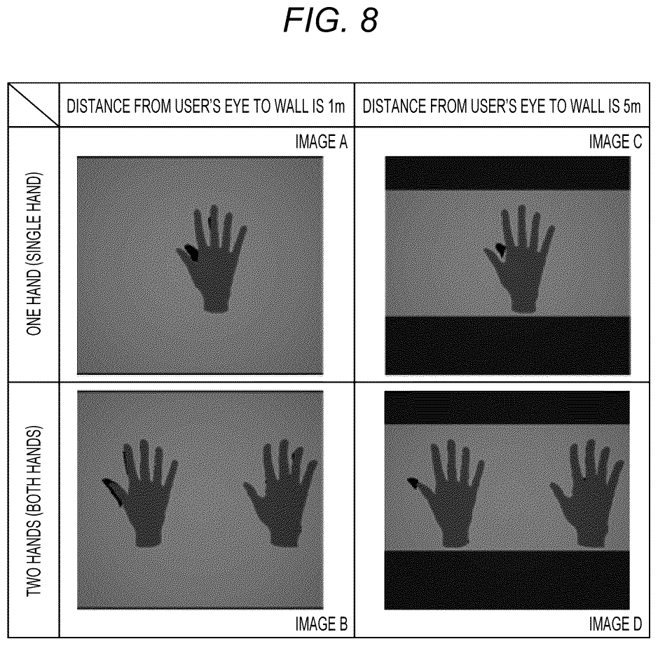

On the other hand, FIG. 8 is a simulation result of an occlusion region generated in a display image by a front object in the arrangement of the color camera 101 and the display 108 according to the present technology illustrated in FIG. 4. In this simulation, the hand of the user wearing the HMD 100 is a front object (an occluding object), and the wall is a rear object. The hand shall be located 25 cm from the user's eye.

Of the four images illustrated in FIG. 8, two on the left (image A and image B) illustrate a case where the distance from the user's eye to the wall (rear object) is 1 m, and two on the right (image C and image D) illustrate a case where the distance from the user's eye to the wall (rear object) is 5 m.

Furthermore, among the four images illustrated in FIG. 8, the upper two (image A and image C) illustrate a case where only one hand (front object) of the user exists within the angle of view. Furthermore, the lower two images (image B and image D) illustrate a case where both hands (front object) of the user exist within the angle of view. Note that, in the image B and the image D, the right hand is the user's right hand with the palm facing the direction opposite to the direction of the user's face (the direction of the user's line-of-sight), and the left hand is the user's left hand with the palm facing the direction of the user's face.

It can be seen that, in a case where the distance from the user's eye to the wall (rear object) is 1 m and 5 m, in a case where the hand (front object) is one hand, and in a case where the hand is both hands, although a slight occlusion region remains, the occlusion region is reduced as compared with the case of the conventional arrangement. From this simulation result, it can be seen that arrangement such that the interval between the left camera 101L and the right camera 101R is wider than the interval (interocular distance) between the left display 108L and the right display 108R as in the present technology is effective in reducing the occlusion region.

### [1-2. Processing by Information Processing Apparatus 200]

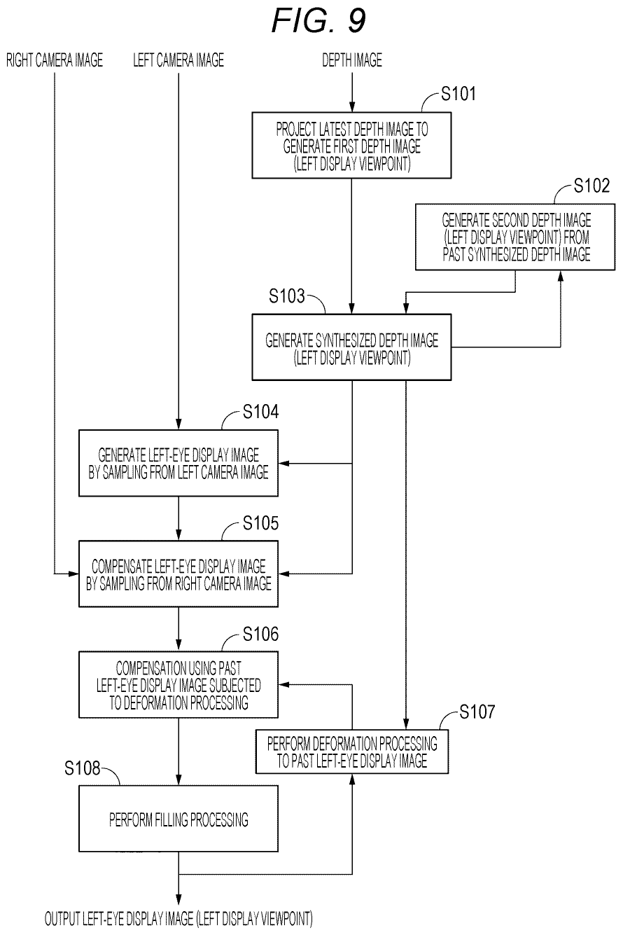

Next, processing by the information processing apparatus 200 will be described with reference to FIGS. 9 to 13.

The information processing apparatus 200 uses the left camera image captured by the left camera 101L and the depth image obtained by the distance measurement sensor 102 to generate the left-eye display image at the left display viewpoint (the viewpoint of the left eye of the user) where the left camera 101L does not actually exist. The left-eye display image is displayed on the left display 108L.

Furthermore, the information processing apparatus 200 uses the right camera image captured by the right camera 101R and the depth image obtained by the distance measurement sensor 102 to generate the right-eye display image at the right display viewpoint (the viewpoint of the right eye of the user) where the right camera 101R does not actually exist. The right-eye display image is displayed on the right display 108R.

The left camera 101L, the right camera 101R, and the distance measurement sensor 102 are controlled by a predetermined synchronization signal, perform image-capturing and sensing at a frequency of, for example, about 60 times/second or 120 times/second, and output a left camera image, a right camera image, and a depth image to the information processing apparatus 200.

The following processing is executed for each image output (this unit is referred to as a frame). Note that generation of the left-eye display image from the left display viewpoint displayed on the left display 108L will be described below with reference to FIGS. 9 to 12.

In the case of generating the left-eye display image, of the left camera 101L and the right camera 101R, the left camera 101L closest to the left display 108L is set as the main camera, and the right camera 101R second closest to the left display 108L is set as the sub camera. Then, a left-eye display image is created on the basis of the left camera image captured by the left camera 101L as the main camera, and an occlusion region in the left-eye display image is compensated using the right camera image captured by the right camera 101R as the sub camera.

First, in step S101, the latest depth image generated by performing depth estimation from the information obtained by the distance measurement sensor 102 is projected onto the left display viewpoint as a virtual viewpoint to generate a first depth image (left display viewpoint). This is processing for generating a synthesized depth image at the left display viewpoint in step S103 described later.

Next, in step S102, the past synthesized depth image (left display viewpoint) generated in the processing in step S103 in the past frame (previous frame) is subjected to the deformation processing in consideration of the variation in the position of the user to generate the second depth image (left display viewpoint).

The deformation in consideration of the variation of the position of the user means, for example, that the depth image of the left display viewpoint before the variation of the position of the user and the depth image of the left display viewpoint after the variation of the position of the user are deformed such that all pixels coincide with each other. This is also processing for generating the synthesized depth image at the left display viewpoint in step S103 described later.

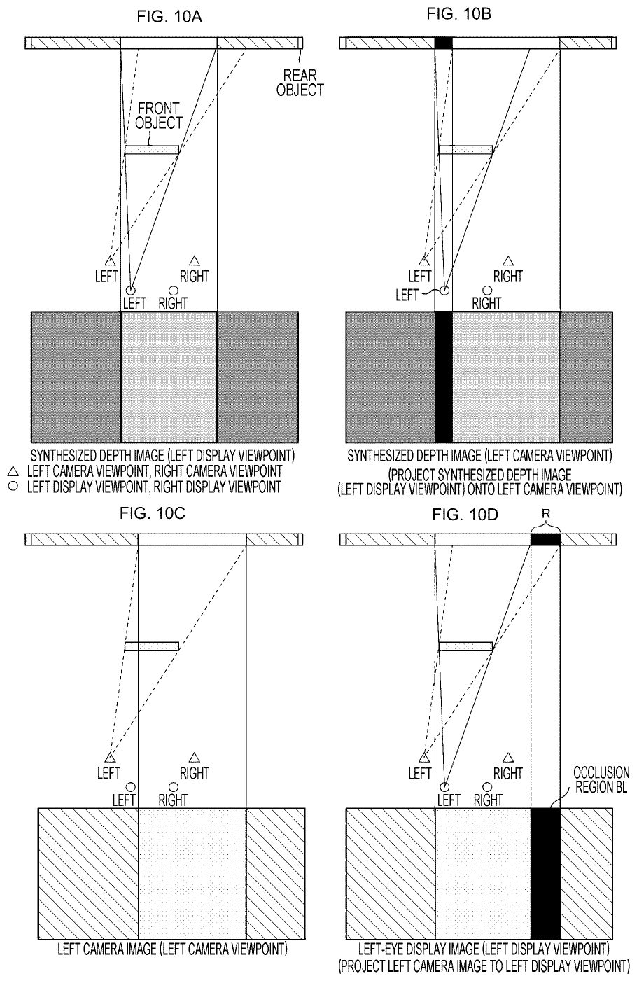

Next, in step S103, the first depth image generated in step S101 and the second depth image generated in step S102 are synthesized to generate the latest synthesized depth image (left display viewpoint) (image illustrated in FIG. 10A) at the left display viewpoint.

Note that, in order to use the synthesized depth image (left display viewpoint) at the time of the past frame for processing of the current frame, it is necessary to store the synthesized depth image (left display viewpoint) generated by the processing in the past frame by buffering.

Next, in step S104, pixel values of colors of the left display viewpoint are sampled from the left camera image captured by the left camera 101L that is the main camera closest to the left display viewpoint that is the virtual viewpoint. A left-eye display image (left display viewpoint) is generated by this sampling.

In order to perform sampling from the left camera image, first, the latest synthesized depth image (left display viewpoint) generated in step S103 is projected onto the left camera viewpoint to generate a synthesized depth image (left camera viewpoint) (image illustrated in FIG. 10B). Z-Test is performed on a portion overlapping with respect to the depth, and drawing is preferentially performed at a short distance. Then, the left camera image (left camera viewpoint) (the image illustrated in FIG. 10C) is projected onto the left display viewpoint using the synthesized depth image (left camera viewpoint).

The projection of the left camera image (left camera viewpoint) onto the left display viewpoint will be described. When the synthesized depth image (left display viewpoint) created in step S103 described above is projected onto the left camera viewpoint as described above, it is possible to grasp a correspondence relationship between the pixels of the left display viewpoint and the left camera viewpoint, that is, a correspondence relationship between the pixels that each pixel of the synthesized depth image (left camera viewpoint) corresponds to which pixel of the synthesized depth image (left display viewpoint). The pixel correspondence relationship information is stored in a buffer or the like.

By using the pixel correspondence relationship information, each pixel of the left camera image (left camera viewpoint) can be projected onto each corresponding pixel in the left display viewpoint, and the left camera image (left camera viewpoint) can be projected onto the left display viewpoint. As a result, the pixel value of the color of the left display viewpoint can be sampled from the left camera image. By this sampling, a left-eye display image (left display viewpoint) (image illustrated in FIG. 10D) can be generated.

However, an occlusion region BL is generated in the left-eye display image (left display viewpoint) as illustrated in FIG. 10D. As illustrated in FIG. 10D, a region R is not blocked by the forward object at the left display viewpoint. On the other hand, at the viewpoint of the left camera, the region R is blocked by the front object, and the pixel value cannot be obtained. Therefore, when pixel values of colors from the left camera viewpoint to the left display viewpoint are sampled, the occlusion region BL occurs in the left-eye display image (left display viewpoint).

Next, in step S105, the occlusion region BL in the left-eye display image (left display viewpoint) is compensated. The occlusion region BL is compensated by sampling a color pixel value from a right camera image captured by the right camera 101R, which is a sub camera second closest to the left display viewpoint.

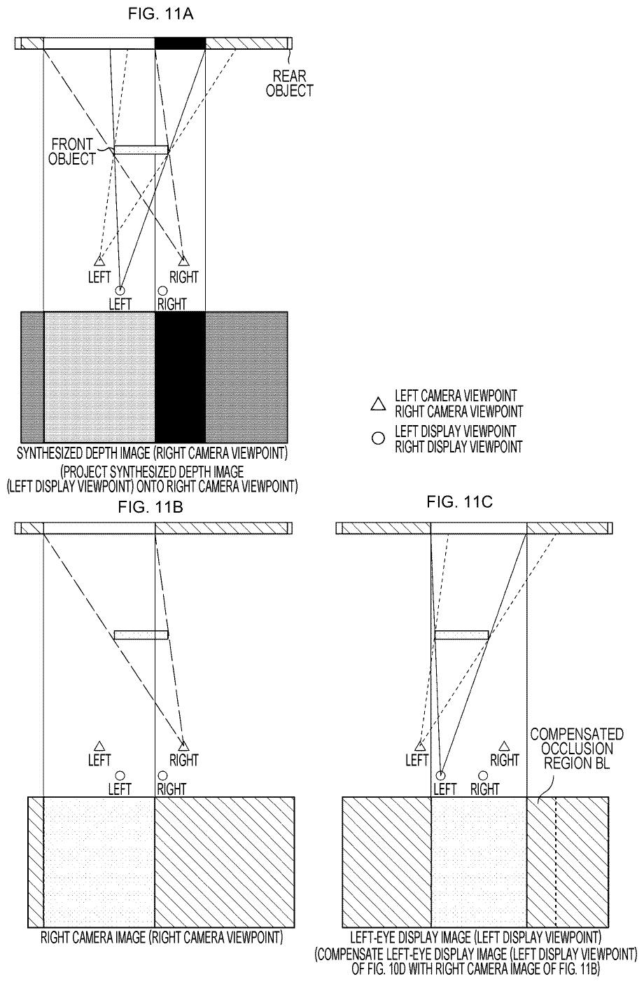

In order to perform sampling from the right camera image, first, the synthesized depth image (left display viewpoint) generated in step S103 is projected onto the right camera viewpoint to generate a synthesized depth image (right camera viewpoint) (image illustrated in FIG. 11A). Z-Test is performed on a portion overlapping with respect to the depth, and drawing is preferentially performed at a short distance.

Then, using the synthesized depth image (right camera viewpoint), the right camera image (right camera viewpoint) (image illustrated in FIG. 11B) is projected onto the left display viewpoint. The projection of the right camera image (right camera viewpoint) onto the left display viewpoint using the synthesized depth image (right camera viewpoint) can be performed in a similar manner to the above-described method of projecting the left camera image (left camera viewpoint) onto the left display viewpoint using the synthesized depth image (left camera viewpoint).

Since the occlusion region BL illustrated in FIG. 10D is seen from the right camera viewpoint and a color pixel value can be obtained from the right camera image, the occlusion region BL can be compensated by projecting the right camera image (right camera viewpoint) onto the left display viewpoint. As a result, the left-eye display image (the image illustrated in FIG. 11C) in which the occlusion region BL is compensated for can be generated.

Next, in step S106, an occlusion region (remaining occlusion region) remaining in the left-eye display image without being compensated by the processing in step S105 is compensated. Note that, in a case where all the occlusion regions are compensated by the processing of step S105, step S106 does not need to be performed. In that case, the left-eye display image whose occlusion region has been compensated in step S105 is finally output as a left-eye display image to be displayed on the left display 108L.

This compensation of the remaining occlusion region is performed by sampling from the deformed left-eye display image generated by applying deformation in consideration of variation in the position of the user to the left-eye display image (left display viewpoint), which is the final output in the past frame (previous frame) in step S107. When this deformation is performed, the synthesized depth image in the past frame is used, and the movement amount of the pixel is determined on the assumption that there is no shape change in the subject as the imaging target.

Next, in step S108, filling processing is performed using a color compensation filter or the like in order to compensate for the residual occlusion region remaining in the left-eye display image without being compensated in the process of step S106. Then, the left-eye display image subjected to the filling processing in step S108 is finally output as a left-eye display image to be displayed on the left display 108L. Note that, in a case where all the occlusion regions are compensated by the processing of step S106, step S108 does not need to be performed. In this case, the left-eye display image generated in step S106 is finally output as a left-eye display image to be displayed on the left display 108L.

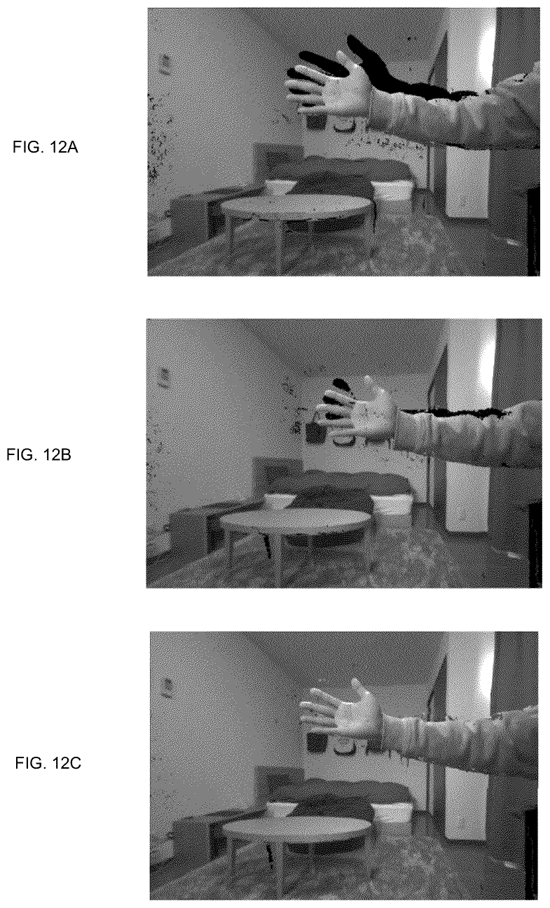

FIG. 12 is an example of an image showing a specific result of processing by the information processing apparatus 200. All of the three images in FIGS. 12A to 12C are left-eye display images created from the left display viewpoint as the virtual viewpoint. A black region in the image indicates an occlusion region.

FIG. 12A illustrates the left-eye display image generated as a result of executing up to step S104. FIG. 12B illustrates the left-eye display image generated as a result of performing the compensation in step S105 on the left-eye display image in FIG. 12A. At this point, it can be seen that many occlusion regions existing in the left-eye display image in FIG. 12A are compensated.

Moreover, FIG. 12C illustrates the left-eye display image generated as a result of performing the compensation in steps S106 and S107. At this point, it can be seen that the occlusion region existing in the left-eye display image in FIGS. 12A and 12B is compensated and almost disappears. As described above, in the present technology, it is possible to reduce the occlusion region generated in the image by compensating for the occlusion region.

As described above, the left-eye display image to be displayed on the left display 108L is generated.

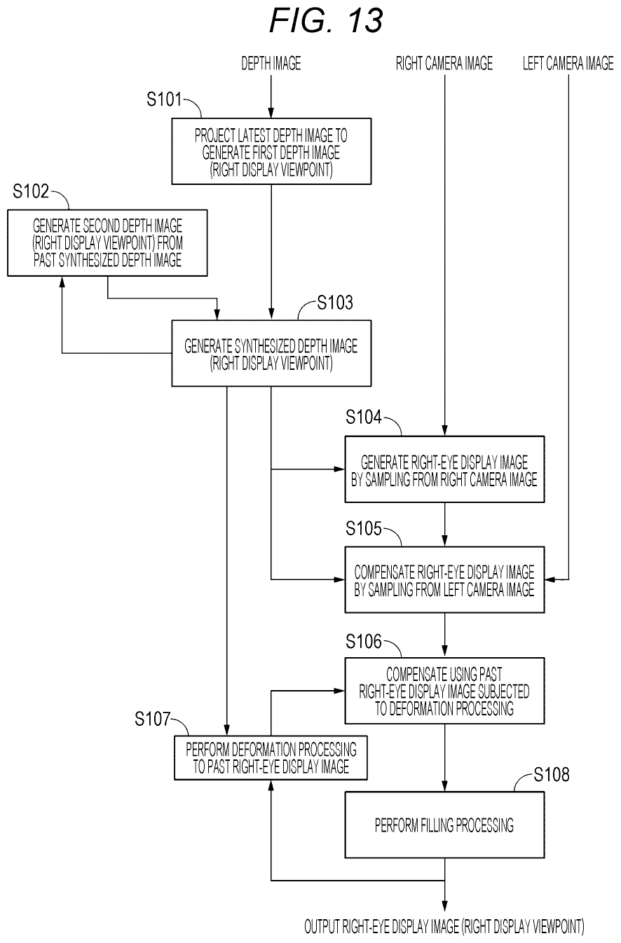

FIG. 13 is a process block of the information processing apparatus 200 for generating a right-eye display image from the right display viewpoint to be displayed on the right display 108R. The right-eye display image displayed on the right display 108R can also be generated by processing similar to that of the left-eye display image. However, in the case of generating the right-eye display image, the main camera is the right camera 101R, and the sub camera is the left camera 101L.

The processing in the first embodiment is performed as described above. According to the present technology, by disposing the left camera 101L and the right camera 101R such that the interval between the left camera 101L and the right camera 101R is wider than the interocular distance of the user, it is possible to reduce the occlusion region caused by the occluding object. Moreover, by compensating the occlusion region with the image captured by the color camera 101, it is possible to generate a display image with a reduced occlusion region or a left-eye display image and a right-eye display image without an occlusion region.

### 2. Second Embodiment

### [2-1. Description of Distance Measurement Error]

Next, a second embodiment of the present technology is described. The configuration of the HMD 100 is similar to that of the first embodiment.

As described in the first embodiment, in the present technology, the depth image of the left display viewpoint as the virtual viewpoint is generated for generating the left-eye display image, and the depth image of the right display viewpoint as the virtual viewpoint is generated for generating the right-eye display image. However, the distance measurement result by the distance measurement sensor 102 for generating the depth image may include an error (Hereinafter, this is referred to as a distance measurement error.). In the second embodiment, the information processing apparatus 200 generates a left-eye display image and a right-eye display image, and performs processing of detecting and correcting a distance measurement error.

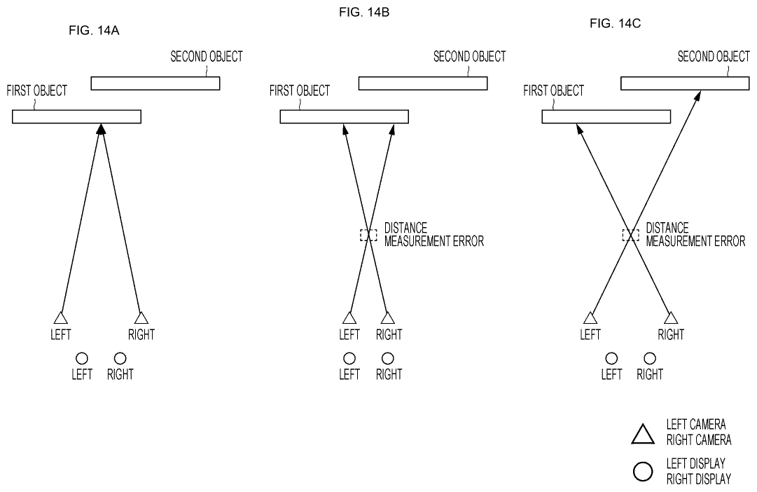

Here, detection of a distance measurement error will be described with reference to FIG. 14 by exemplifying a case where the left camera, the right camera, the left display, the right display, and the first object and the second object that are subjects are present.

In the generation of the left-eye display image, the synthesized depth image generated in step S103 is projected onto the left camera viewpoint in step S104, and further, the synthesized depth image is projected onto the right camera viewpoint in step S105. At this time, focusing on any pixel in the synthesized depth image of the projection source, in a case where there is no distance measurement error, sampling is performed from each of the left camera image and the right camera image obtained by capturing the same position by the left camera and the right camera as illustrated in FIG. 14A, so that pixel values of substantially the same color can be obtained.

On the other hand, in a case where there is a distance measurement error, an image is sampled on the basis of an erroneous depth value, and thus pixel values are sampled from a left camera image and a right camera image obtained by capturing different positions by the left camera and the right camera. Therefore, in the generation of the left-eye display image from the left display viewpoint, it is possible to determine that the depth value in the synthesized depth image of the projection source is different, that is, there is a distance measurement error in a region in which the result of sampling the pixel value from the left camera image and the result of sampling the pixel value from the right camera image are greatly different.

FIGS. 14B and 14C both illustrate a state in which the distance measurement result of the distance measurement sensor includes a distance measurement error. FIG. 14B illustrates a case where the interval between the left camera and the right camera is the same as the interval (interocular distance) between the left display and the right display as in the related art, and FIG. 14C illustrates a case where the interval between the left camera and the right camera is larger than the interval (interocular distance) between the left display and the right display as in the present technology.

In the case of FIG. 14B, when pixel values are sampled from each of the left camera image captured by the left camera and the right camera image captured by the right camera on the basis of an incorrect depth value, positions of objects to be sampled in the left camera image and the right camera image are different, but an interval between the positions is smaller than that in the case of FIG. 14C. Therefore, even if there is a distance measurement error, there is a high possibility that pixel values are sampled from the left camera image and the right camera image as a result of capturing close positions of the same first object, and there is a high possibility that the same or approximate color is obtained from the left camera image and the right camera image. Then, since there is a low possibility that a difference in color or the like at the different positions can be detected, it is difficult to detect a distance measurement error.

On the other hand, in the case of FIG. 14C, the interval between the positions of the objects to be sampled is larger than that in the case of FIG. 14B as compared with the case of FIG. 14B. Therefore, as illustrated in FIG. 14C, there is a high possibility that pixel values are sampled from the left camera image and the right camera image that are results of capturing different objects such as the first object and the second object, and there is a high possibility that different colors are obtained from the left camera image and the right camera image. Then, there is a high possibility that a difference in color or the like at the different positions can be detected, and it is easy to detect a distance measurement error. In this way, by widening the interval between the left camera and the right camera, it is easy to detect a distance measurement error.

### [2-2. Processing by Information Processing Apparatus 200]

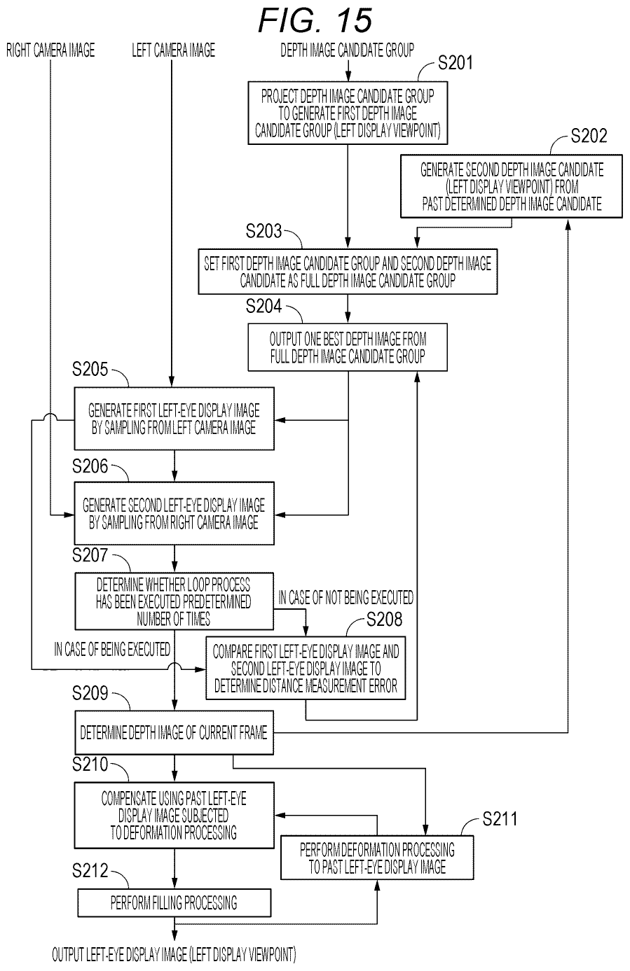

Next, processing by the information processing apparatus 200 will be described with reference to FIG. 15.

Similarly to the first embodiment, the information processing apparatus 200 uses the left camera image captured by the left camera 101L and the depth image obtained by the distance measurement sensor 102 to generate the left-eye display image at the left display viewpoint (the viewpoint of the left eye of the user) where the left camera 101L does not actually exist. The left-eye display image is displayed on the left display 108L.

Furthermore, similarly to the first embodiment, the information processing apparatus 200 uses the right camera image captured by the right camera 101R and the depth image obtained by the distance measurement sensor 102 to generate the right-eye display image at the right display viewpoint (the viewpoint of the right eye of the user) where the right camera 101R does not actually exist. The right-eye display image is displayed on the right display 108R.

Note that the definitions of the left camera viewpoint, the right camera viewpoint, the left display viewpoint, the right display viewpoint, and the distance measurement sensor viewpoint are similar to those in the first embodiment.

The left camera 101L, the right camera 101R, and the distance measurement sensor 102 are controlled by a predetermined synchronization signal, perform image-capturing and sensing at a frequency of, for example, about 60 times/second or 120 times/second, and output a left camera image, a right camera image, and a depth image to the information processing apparatus 200.

Similarly to the first embodiment, the following processing is executed for each image output (this unit is referred to as a frame). Note that generation of the left-eye display image from the left display viewpoint displayed on the left display 108L will be described with reference to FIG. 15. Furthermore, in a case where the left-eye display image is generated, similarly to the first embodiment, the left camera 101L closest to the left display 108L is set as the main camera, and the right camera 101R second closest to the left display 108L is set as the sub camera.

In the second embodiment, the distance measurement sensor 102 outputs a plurality of depth image candidates (depth image candidates) used in processing of the information processing apparatus 200 in one frame. Pixels at the same position of the plurality of depth image candidates have different depth values. Hereinafter, the plurality of depth image candidates may be referred to as a depth image candidate group. It is assumed that each depth image candidate is ranked in advance based on the reliability of the depth value. This ranking can be performed using an existing algorithm.

First, in step S201, the latest depth image candidate group obtained by the distance measurement sensor 102 is projected onto the left display viewpoint to generate a first depth image candidate group (left display viewpoint).

Next, in step S202, the past determined depth image candidate (left display viewpoint) generated in the processing in step S209 in the past frame (previous frame) is subjected to the deformation processing in consideration of the variation in the position of the user to generate the second depth image candidate (left display viewpoint). The deformation considering the variation of the user position is similar to that in the first embodiment.

Next, in step S203, both the first depth image candidate group (left display viewpoint) generated in step S201 and the second depth image candidate (left display viewpoint) generated in step S202 are collectively set as a full depth image candidate group (left display viewpoint).

Note that, in order to use the first depth image candidate group (left display viewpoint) at the time point of the past frame for the processing of the current frame, it is necessary to store the determined depth image (left display viewpoint) generated as a result of the processing in step S209 in the past frame by buffering.

Next, in step S204, one depth image candidate (left display viewpoint) having the best depth value is output from the full depth image candidate group (left display viewpoint). The depth image candidate having the best depth value is set as the best depth image. The best depth image is a depth image candidate having the highest reliability (first reliability) among a plurality of depth image candidates ranked in advance on the basis of the reliability of the depth value.

Next, in step S205, pixel values of colors of the left display viewpoint are sampled from the left camera image captured by the left camera 101L that is the main camera closest to the left display viewpoint that is the virtual viewpoint. As a result, the first left-eye display image is generated.

In order to perform sampling from the left camera image, first, the best depth image (left display viewpoint) output in step S204 is projected onto the left camera viewpoint to generate the best depth image (left camera viewpoint). Z-Test is performed on a portion overlapping with respect to the depth, and drawing is preferentially performed at a short distance.

Then, using the best depth image (left camera viewpoint), the left camera image (left camera viewpoint) captured by the left camera 101L is projected onto the left display viewpoint. This projection processing is similar to step S104 in the first embodiment. The first left-eye display image (left display viewpoint) can be generated by this sampling.

Next, in step S206, color pixel values are sampled from the right camera image captured by the right camera 101R as the sub camera for all the pixels constituting the display image displayed on the left display 108L. The sampling from the right camera image is performed in a similar manner to step S105 using the best depth image instead of the synthesized depth image in step S105 of the first embodiment. As a result, the second left-eye display image (left display viewpoint) is generated.

Steps S204 to S208 are configured as a loop process, and this loop process is executed a predetermined number of times with the number of depth image candidates included in the depth image candidate group as an upper limit. Therefore, the loop process is repeated until a predetermined number of times is executed. In a case where the loop process has not been executed the predetermined number of times, the process proceeds to step S208 (No in step S207).

Next, in step S208, the first left-eye display image (left display viewpoint) generated in step S205 is compared with the second left-eye display image (left display viewpoint) generated in step S206. In this comparison, the pixel values of the pixels at the same position in the region that is not the occlusion region are compared in both the first left-eye display image (left display viewpoint) and the second left-eye display image (left display viewpoint). Then, the depth value of the pixel in which the difference between the pixel values is a predetermined value or more is determined to be a distance measurement error and is invalidated.

Since the first left-eye display image (left display viewpoint) is a result of sampling from the left camera image and the second left-eye display image (left display viewpoint) is a result of sampling from the right camera image, it can be said that there is a high possibility that the pixel values of the pixels at the same position are different from each other by a predetermined value or more from the left camera image and the right camera image obtained by capturing different objects by the left camera 101L and the right camera 101R as illustrated in FIG. 14C. Therefore, in a pixel having a pixel value different by a predetermined value or more, it can be determined that the depth value in the depth image candidate of the projection source is different, that is, there is a distance measurement error.

Steps S204 to S208 are configured as a loop process, and after the determination of the distance measurement error is performed in step S208, the process returns to step S204, and steps S204 to S208 are performed again.

As described above, one best depth image having the best depth value is output from the depth image candidate group in step S204, but in step S204 in the loop process of the second cycle, the pixel determined to be invalid in step S208 among the best depth images output in the previous loop is replaced with the pixel value of the depth image candidate having the second reliability, and the replaced pixel value is output as the best depth image. Moreover, in step S204 in the loop process of the third cycle, a pixel determined to be invalid among the best depth images output in the loop of the second cycle is output as a depth image candidate having the third reliability as the best depth image. Each time the loop process is repeated in this manner, the best depth image replaced by lowering the rank is output for the pixel determined to be invalid in step S208.

Then, when the loop process is executed a predetermined number of times, the loop ends, and the process proceeds from step S207 to step S209. Then, in step S209, the best depth image to be processed at the end of the loop is determined as the depth image of the left display viewpoint of the current frame.

Note that a pixel whose depth value is determined to be invalid in step S208 even if any depth image candidate is used is compensated using a value estimated from the depth values of surrounding pixels, some depth value of the depth image candidate, or the like.

Note that the occlusion region in the first left-eye display image (left display viewpoint) is compensated using the second left-eye display image (left display viewpoint). This compensation can be realized by processing similar to the compensation in step S105 of the first embodiment. The first left-eye display image (left display viewpoint) in which the occlusion region is compensated with the second left-eye display image (left display viewpoint) is set as the left-eye display image. Furthermore, at the time of generating the left-eye display image, the pixel value of the first left-eye display image is used for pixels having different pixel values even though the occlusion region in the first left-eye display image (left display viewpoint) is not the occlusion region in any of the second left-eye display images (left display viewpoint), that is, pixels determined to be beyond in step S208 to the end.

Next, in step S210, the occlusion region (remaining occlusion region) remaining in the left-eye display image is compensated without being compensated by the compensation using the second left-eye display image. Note that, in a case where all the occlusion regions are compensated using the second left-eye display image, step S210 does not need to be performed. In this case, the left-eye display image compensated by the second left-eye display image is finally output as the left-eye display image to be displayed on the left display 108L.

This compensation of the residual occlusion region is performed in step S211 by sampling from the deformed left-eye display image obtained by deforming the left-eye display image (left display viewpoint), which is the final output in the past frame (previous frame), similarly to step S107 in the first embodiment.

Next, in step S212, a filling process is performed using a color compensation filter or the like in order to compensate for the residual occlusion region remaining in the left-eye display image without being compensated in the processing of step S210. Then, the left-eye display image subjected to the filling processing is finally output as a left-eye display image to be displayed on the left display 108L. Note that, in a case where all the occlusion regions are compensated by the processing of step S210, step S211 does not need to be performed. In this case, the left-eye display image generated in step S210 is finally output as a left-eye display image to be displayed on the left display 108L.

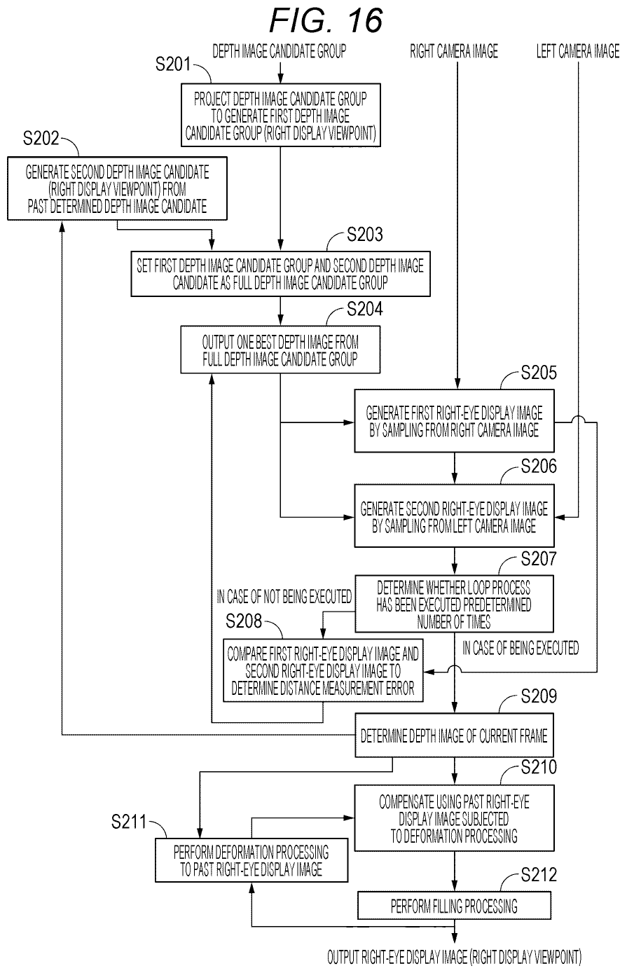

FIG. 16 illustrates a process block of the information processing apparatus 200 for generating a right-eye display image to be displayed on the right display 108R in the second embodiment. The right-eye display image displayed on the right display 108R can also be generated by processing similar to that of the left-eye display image, and detection and correction of a distance measurement error can also be performed. Note that, in the case of generating the right-eye display image, the main camera is the right camera 101R, and the sub camera is the left camera 101L.

The processing in the second embodiment is performed as described above. According to the second embodiment, similarly to the first embodiment, it is possible to generate a left-eye display image and a right-eye display image with a reduced occlusion region or without an occlusion region, and further detect and correct a distance measurement error.

### 3. Modifications

Although the embodiment of the present technology has been specifically described above, the present technology is not limited to the above-described embodiments, and various modifications based on the technical idea of the present technology are possible.

First, a modification of the hardware configuration of the HMD 100 will be described. The configuration and arrangement of the color camera 101 and the distance measurement sensor 102 included in the HMD 100 according to the present technology are not limited to those illustrated in FIG. 1.

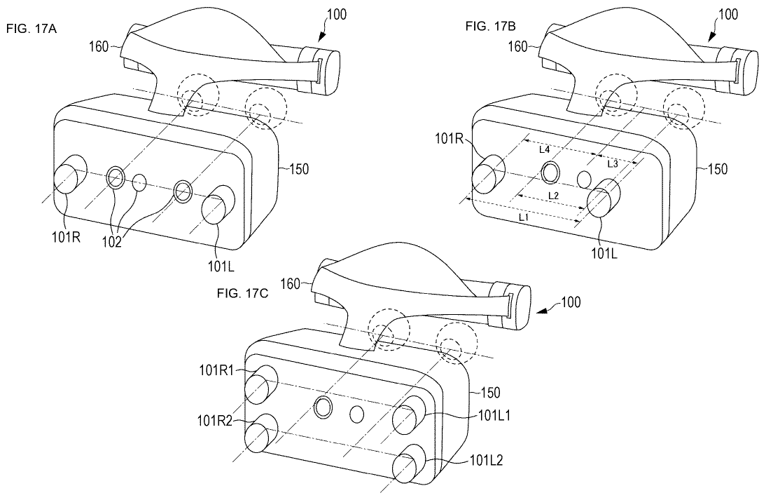

FIG. 17A illustrates an example in which the distance measurement sensor 102 includes a stereo camera. Similarly to the left camera 101L and the right camera 101R, the distance measurement sensor 102 constituted by a stereo camera may be disposed at any position as long as it faces the direction of the user's line-of-sight.

FIG. 17B illustrates an example in which the interval L1 between the left camera 101L and the right camera 101R is larger than the interocular distance L2, and the left camera 101L and the right camera 101R are disposed at left-right asymmetric positions with respect to a substantial center of the left eye and the right eye of the user. In FIG. 17B, the left camera 101L and the right camera 101R are disposed such that an interval L4 from the substantial center of the left eye and the right eye to the right camera 101R is wider than an interval L3 from the substantial center of the left eye and the right eye to the left camera 101L. Conversely, the left camera 101L and the right camera 101R may be disposed such that the interval from the substantial center of the left eye and the right eye to the left camera 101L is wider than the interval from the substantial center of the left eye and the right eye to the right camera 101R. In the present technology, the interval between the left camera 101L and the right camera 101R is wider than the interocular distance of the user, and thus the left camera and the right camera may be disposed in this manner.

FIG. 17C illustrates an example in which a plurality of the left cameras 101L and a plurality of the right cameras 101R are disposed. The left camera 101L1 and the left camera 101L2 on the left side are disposed vertically, the left camera 101L1 on the upper side is disposed to be located above the height of the user's eye, and the left camera 101L2 on the lower side is disposed to be located below the height of the user's eye. The right camera 101R1 and the right camera 101R2 on the right side are also similar. Similarly to the case where the occlusion region in the lateral direction generated by the occluding object is compensated by using the left camera 101L and the right camera 101R in the embodiments, the occlusion region generated in the vertical direction by the occluding object can be compensated by disposing the color camera 101 so as to sandwich the height of the eye at the vertical position. In this case, processing may be performed similarly to the first or second embodiment by using one of the upper camera and the lower camera as the main camera and the other camera as the sub camera.

Next, a modification of the processing by the information processing apparatus 200 will be described.

In the embodiments, in order to generate the left-eye display image of the left display viewpoint, processing of projecting the synthesized depth image of the left display viewpoint to the left camera viewpoint in step S104 and further projecting the synthesized depth image of the left display viewpoint onto the right camera viewpoint in step S105 is performed.

Furthermore, in order to generate the right-eye display image of the right display viewpoint, it is necessary to project the synthesized depth image of the right display viewpoint onto the right camera viewpoint in step S104, and further project the synthesized depth image of the right display viewpoint onto the left camera viewpoint in step S105. Therefore, it is necessary to project the synthesized depth image four times in the processing of each frame.

On the other hand, in this modification, in order to generate the left-eye display image of the left display viewpoint, the synthesized depth image of the right display viewpoint is projected onto the right camera viewpoint in step S105. This is the same processing as the processing of projecting the synthesized depth image of the right display viewpoint onto the right camera viewpoint performed in step S104 for generating the right-eye display image of the right display viewpoint on the opposite side, and thus can be realized by using the result.

Furthermore, in order to generate the right-eye display image of the right display viewpoint, the synthesized depth image of the left display viewpoint is projected onto the left camera viewpoint in step S105. This is the same as the processing of projecting the synthesized depth image of the left display viewpoint onto the left camera viewpoint performed in step S104 for generating the left-eye display image of the left display viewpoint on the opposite side, and thus can be realized by using the result.

Note that, for this purpose, it is necessary to pay attention to the order of the processing for generating the left-eye display image and the processing for generating the right-eye display image. Specifically, after the synthesized depth image (left display viewpoint) is projected onto the left camera viewpoint in step S104 for generating the left-eye display image, before the synthesized depth image (right display viewpoint) is projected onto the right camera viewpoint for generating the left-eye display image, it is necessary to project the synthesized depth image (right display viewpoint) onto the right camera viewpoint in step S104 for generating the right-eye display image.

Then, the projection of the synthesized depth image (right display viewpoint) for generating the left-eye display image onto the right camera viewpoint uses the processing result of step S104 for generating the right-eye display image. Furthermore, the processing result of step S104 for generating the left-eye display image is used for the projection of the synthesized depth image (left display viewpoint) for generating the right-eye display image onto the left camera viewpoint.

Therefore, the projection processing in each frame is only processing of projecting the depth image of the left display viewpoint onto the left camera viewpoint and processing of projecting the depth image of the right display viewpoint onto the right camera viewpoint, and the processing load can be reduced as compared with the embodiments.

Furthermore, in the embodiments, in order to generate the left-eye display image from the left display viewpoint, the pixel values of colors are sampled from the right camera image captured by the right camera 101R in step S105 described above. Furthermore, in order to generate a right-eye display image from the right display viewpoint, color pixel values are sampled from the left camera image captured by the left camera 101L. In order to reduce the calculation amount of the sampling processing, sampling may be performed in an image space having a resolution lower than the resolution of the original camera.

Furthermore, in step S105 of the first embodiment, in order to compensate for the occlusion region of the left-eye display image generated in step S104, sampling processing is performed on pixels in the occlusion region. However, the sampling processing may be performed on all the pixels of the left-eye display image in step S105, and the pixel value of the pixel constituting the left-eye display image may be determined by the weighted average with the sampling result in step S104. When blending of the sampling result in step S104 and the sampling result in step S105 is performed, blending and blurring processing are performed not only for pixels but also for peripheral pixels, so that it is possible to particularly suppress generation of an unnatural hue due to a difference between cameras at a boundary portion where sampling is performed only from one camera.

Moreover, there is a case where the HMD 100 includes a sensor camera other than the color camera 101 for use as a distance measurement sensor used for recognition of a user position and distance measurement. In that case, the pixel information obtained by the sensor camera may be sampled by a method similar to step S104. In a case where the sensor camera is a monochrome camera, the following processing may be performed.

A monochrome image captured by the monochrome camera is converted into a color image (in the case of RGB, R, G, and B are set to the same values), and blending and blurring processing are performed in a similar manner to the above-described modification.

A sampling result from a color image and a sampling result from a monochrome image are converted into a hue, saturation, value (HSV) space so that brightness values in the HSV space are similar to each other, and there is no abrupt change in brightness at a boundary between the color image and the monochrome image.

The color image is converted into a monochrome image, and all processing is performed on the monochrome image. At this time, blending or blurring processing similar to the above-described modification may be performed in the monochrome image space.

The present technology can also have the following configurations.

(1)

A head mount display including:
a left display that displays a left-eye display image;
a right display that displays a right-eye display image;
a housing that supports the left display and the right display so as to be located in front of eyes of a user; and
a left camera that captures a left camera image, and a right camera that captures a right camera image, the left camera and the right camera being provided outside the housing, in which
an interval between the left camera and the right camera is wider than an interocular distance of the user.
   (2)

The head mount display according to (1), in which
the left camera and the right camera are provided in the housing toward a direction of a line-of-sight of the user, and capture an outside world in the direction of the line-of-sight of the user.
   (3)

The head mount display according to (1) or (2), in which
the left camera and the right camera are provided in front of the left display and the right display in a direction of a line-of-sight of the user.
   (4)

The head mount display according to any one of (1) to (3), in which
the left-eye display image is generated by projecting the left camera image onto a viewpoint of the left display and sampling a pixel value, and
the right-eye display image is generated by projecting the right camera image onto a viewpoint of the right display and sampling a pixel value.
   (5)

The head mount display according to (4), in which
the left-eye display image is compensated by using the right camera image, and
the right-eye display image is compensated using the left camera image.
   (6)

The head mount display according to (4) or (5), in which
the left-eye display image is compensated by using the left-eye display image in a past, and
the right-eye display image is compensated using the right-eye display image in a past.
   (7)

The head mount display according to any one of (1) to (6), in which
a distance measurement sensor is provided in the housing toward a direction of a line-of-sight of the user.
   (8)

The head mount display according to (7), in which
the left camera image is projected onto a viewpoint of the left display by using a depth image obtained by the distance measurement sensor, and
the right camera image is projected onto a viewpoint of the right display by using the depth image.
   (9)

The head mount display according to any one of (1) to (8), in which
a first left-eye display image is generated by projecting the left camera image and sampling a pixel value, a second left-eye display image is generated by projecting the right camera image and sampling a pixel value, and the first left-eye display image and the second left-eye display image are compared to detect a distance measurement error of the distance measurement sensor.
   (10)

The head mount display according to (9), in which
pixel values of pixels at a same position in the first left-eye display image and the second left-eye display image are compared, and it is determined that there is the distance measurement error in a case where the pixel values are different by a predetermined value or more.
   (11)

The head mount display according to any one of (1) to (10), in which
a first right-eye display image is generated by projecting the right camera image and sampling a pixel value, a second right-eye display image is generated by projecting the left camera image and sampling a pixel value, and the first right-eye display image and the second right-eye display image are compared to detect a distance measurement error of the distance measurement sensor.
   (12)

The head mount display according to (11), in which
pixel values of pixels at a same position in the first right-eye display image and the second right-eye display image are compared, and it is determined that there is the distance measurement error in a case where the pixel values are different by a predetermined value or more.
   (13)

The head mount display according to any one of (1) to (12), in which
the interocular distance is a distance from a center of a pupil of a left eye to a center of a pupil of a right eye.
   (14)

The head mount display according to any one of (1) to (13), in which
the interocular distance of the user is a value obtained by statistics.
   (15)

The head mount display according to any one of (1) to (14), in which
two of the left cameras and two of the right cameras are provided.
   (16)

The head mount display according to (3), in which
one of two of the left cameras and one of two of the right cameras are disposed to be located above a height of an eye of the user, and another of the two left cameras and another of the two right cameras are disposed to be located below the height of the eye of the user.
   (17)

An information processing apparatus configured to:
perform processing corresponding to a head mount display including a left camera and a left display, and a right camera and a right display;
generate a left-eye display image by projecting a left camera image captured by the left camera onto a viewpoint of the left display and sampling a pixel value; and
generate a right-eye display image by projecting a right camera image captured by the right camera onto a viewpoint of the right display and sampling a pixel value.
   (18)

The information processing apparatus according to (17), in which
the left-eye display image is compensated by using the right camera image, and
the right-eye display image is compensated using the left camera image.
   (19)

The information processing apparatus according to (17) or (18), in which
a first right-eye display image is generated by projecting the right camera image captured by the right camera and sampling a pixel value, a second right-eye display image is generated by projecting the left camera image captured by the left camera and sampling a pixel value, and the first right-eye display image and the second right-eye display image are compared to detect a distance measurement error of the distance measurement sensor.
   (20)

The information processing apparatus according to any one of (17) to (19), in which
the left-eye display image is compensated by using the left-eye display image in a past, and
the right-eye display image is compensated using the right-eye display image in a past.
   (21)

The information processing apparatus according to any one of (17) to (20), in which
the left camera image is projected onto a viewpoint of the left display by using a depth image obtained by a distance measurement sensor included in the head mount display, and
the right camera image is projected onto a viewpoint of the right display by using the depth image.
   (22)

The information processing apparatus according to any one of (17) to (21), in which
a first left-eye display image is generated by projecting the left camera image captured by the left camera and sampling a pixel value, a second left-eye display image is generated by projecting the right camera image captured by the right camera and sampling a pixel value, and the first left-eye display image and the second left-eye display image are compared to detect a distance measurement error of the distance measurement sensor.
   (23)

The information processing apparatus according to (22), in which
pixel values of pixels at a same position in the first left-eye display image and the second left-eye display image are compared, and it is determined that there is the distance measurement error in a case where the pixel values are different by a predetermined value or more.
   (24)

An information processing method including:
performing processing corresponding to a head mount display including a left camera and a left display, and a right camera and a right display;
generating a left-eye display image by projecting a left camera image captured by the left camera onto a viewpoint of the left display and sampling a pixel value; and
generating a right-eye display image by projecting a right camera image captured by the right camera onto a viewpoint of the right display and sampling a pixel value.

### REFERENCE SIGNS LIST

100 Head mount display (HMD)
101L Left camera
101R Right camera
102 Distance measurement sensor
108L Left display
108R Right display

1. A head mount display comprising:
a left display that displays a left-eye display image;
a right display that displays a right-eye display image;
a housing that supports the left display and the right display so as to be located in front of eyes of a user; and
a left camera that captures a left camera image, and a right camera that captures a right camera image, the left camera and the right camera being provided outside the housing, wherein
an interval between the left camera and the right camera is wider than an interocular distance of the user.

2. The head mount display according to claim 1, wherein
the left camera and the right camera are provided in the housing toward a direction of a line-of-sight of the user, and capture an outside world in the direction of the line-of-sight of the user.

3. The head mount display according to claim 1, wherein
the left camera and the right camera are provided in front of the left display and the right display in a direction of a line-of-sight of the user.

4. The head mount display according to claim 1, wherein
the left-eye display image is generated by projecting the left camera image onto a viewpoint of the left display and sampling a pixel value, and
the right-eye display image is generated by projecting the right camera image onto a viewpoint of the right display and sampling a pixel value.

5. The head mount display according to claim 4, wherein
the left-eye display image is compensated by using the right camera image, and
the right-eye display image is compensated using the left camera image.

6. The head mount display according to claim 4, wherein
the left-eye display image is compensated by using the left-eye display image in a past, and
the right-eye display image is compensated using the right-eye display image in a past.

7. The head mount display according to claim 1, wherein
a distance measurement sensor is provided in the housing toward a direction of a line-of-sight of the user.

8. The head mount display according to claim 7, wherein
the left camera image is projected onto a viewpoint of the left display by using a depth image obtained by the distance measurement sensor, and
the right camera image is projected onto a viewpoint of the right display by using the depth image.

9. The head mount display according to claim 1, wherein
a first left-eye display image is generated by projecting the left camera image and sampling a pixel value, a second left-eye display image is generated by projecting the right camera image and sampling a pixel value, and the first left-eye display image and the second left-eye display image are compared to detect a distance measurement error of the distance measurement sensor.

10. The head mount display according to claim 9, wherein
pixel values of pixels at a same position in the first left-eye display image and the second left-eye display image are compared, and it is determined that there is the distance measurement error in a case where the pixel values are different by a predetermined value or more.

11. The head mount display according to claim 1, wherein
a first right-eye display image is generated by projecting the right camera image and sampling a pixel value, a second right-eye display image is generated by projecting the left camera image and sampling a pixel value, and the first right-eye display image and the second right-eye display image are compared to detect a distance measurement error of the distance measurement sensor.

12. The head mount display according to claim 11, wherein
pixel values of pixels at a same position in the first right-eye display image and the second right-eye display image are compared, and it is determined that there is the distance measurement error in a case where the pixel values are different by a predetermined value or more.

13. The head mount display according to claim 1, wherein
the interocular distance is a distance from a center of a pupil of a left eye to a center of a pupil of a right eye.

14. The head mount display according to claim 1, wherein
the interocular distance of the user is a value obtained by statistics.

15. The head mount display according to claim 1, wherein
two of the left cameras and two of the right cameras are provided.

16. The head mount display according to claim 3, wherein
one of two of the left cameras and one of two of the right cameras are disposed to be located above a height of an eye of the user, and another of the two left cameras and another of the two right cameras are disposed to be located below the height of the eye of the user.

17. An information processing apparatus configured to:
perform processing corresponding to a head mount display including a left camera and a left display, and a right camera and a right display;
generate a left-eye display image by projecting a left camera image captured by the left camera onto a viewpoint of the left display and sampling a pixel value; and
generate a right-eye display image by projecting a right camera image captured by the right camera onto a viewpoint of the right display and sampling a pixel value.

18. The information processing apparatus according to claim 17, wherein
the left-eye display image is compensated by using the right camera image, and
the right-eye display image is compensated using the left camera image.

19. The information processing apparatus according to claim 17, wherein
a first right-eye display image is generated by projecting the right camera image captured by the right camera and sampling a pixel value, a second right-eye display image is generated by projecting the left camera image captured by the left camera and sampling a pixel value, and the first right-eye display image and the second right-eye display image are compared to detect a distance measurement error of the distance measurement sensor.

20. An information processing method comprising:
performing processing corresponding to a head mount display including a left camera and a left display, and a right camera and a right display;
generating a left-eye display image by projecting a left camera image captured by the left camera onto a viewpoint of the left display and sampling a pixel value; and
generating a right-eye display image by projecting a right camera image captured by the right camera onto a viewpoint of the right display and sampling a pixel value.
